(19) United States
(12) Patent Application Publication
(10) Pub. No.: US 2008/0097821 A1
(43) Pub. Date: Apr. 24, 2008

(54) RECOMMENDATIONS UTILIZING META-DATA BASED PAIR-WISE LIFT PREDICTIONS

(75) Inventors: David Max Chickering, Bellevue, WA (US); Christopher A. Meek, Kirkland, WA (US); Asela J. Gunawardana, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/552,467

(22) Filed: Oct. 24, 2006

(51) Int. Cl. G07G 1/00

(52) U.S. Cl. 705/10

(57) ABSTRACT

The subject disclosure pertains to systems and methods for facilitating generation of item recommendations based at least in part upon pair-wise lift. Pair-wise lift is a measure of correlation between a pair of items and is generally calculated based upon past usage data. If usage data is insufficient or unavailable, pair-wise lift for a pair of items can be estimated based upon metadata associated with the items. In other aspects, pair-wise lift can be used to generate an explanation for recommended items. An explanation for an item recommendation can be based upon common metadata features associated with the item pair. The relative impact each metadata feature has on predicted pair-wise lift can be evaluated to determine the common feature(s) most likely to have caused the item to be recommended.

### BACKGROUND

The amount of data and other resources available to information seekers has grown astronomically, whether as the result of the proliferation of information sources on the Internet, private efforts to organize business information within a company, or any of a variety of other causes. Accordingly, the increasing volume of available information and/or resources items makes it increasingly difficult for users to review and select desired data or resources. As the amount of available data and resources has grown, so has the need to be able to automatically locate relevant or desired items.

Users can rely on recommendations from experts, friends or any individual or entity that publishes reviews. For example, users can base selections upon critical reviews of movies, television shows, books, music, new technology and the like. However, critical reviews are typically the opinion of a single individual, whose tastes and preferences may vary significantly from those of the user. Additionally, no one critic can view and publish reviews of all available items. Consequently, users are either limited to items reviewed by a trusted critic or selections recommended by a set of disparate individuals of varying degrees of reliability.

Increasingly, users rely on automated systems to filter the universe of data and/or resources and locate, retrieve or even suggest desirable data and resources. However, many of the popular search engines are limited in their effectiveness. For example, certain automated systems search for items based upon keywords entered by users. However, there are many types of data items that cannot be easily searched based upon keywords. For example, digital images as well as audio and video files cannot be quickly evaluated based upon the presence or absence of particular words.

Automatic recommendation systems that evaluate user selections and generate lists of items with which users may wish to interact are becoming increasingly popular as a means to filter available data and resources. The generated lists can include items a user may wish to purchase in the future, items the user may wish to be entertained with next, or any other set of items that may be desired by the user. There are several methods for generating recommendations, each having its own limitations. In collaborative filtering, lists are generated by observing usage patterns of many users. The usage patterns are then used to predict what the current user would like. Collaborative filtering is applicable to many media types (e.g., documents, books, articles, music, movies, etc.).

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the provided subject matter concerns facilitating generation of item recommendations for users. Typically, collaborative filtering recommendation systems rely upon usage patterns in generating recommended lists of items. The probability that a user will enjoy an item can be predicted based in part upon the user's enjoyment of a previous item. The increase in likelihood that a user will enjoy an item based upon his or her enjoyment of a previous item is known as pair-wise lift. Pair-wise lift is a measurement of the correlation between a pair of items typically calculated based upon usage data for the pair. When new items are added to a set of available items, the recommendation system may lack necessary usage data to generate pair-wise lift and generate recommendations for the new item.

The systems and methods described herein can be utilized to facilitate prediction of pair-wise lift for use in generation of item recommendations where actual usage data is unavailable or insufficient. Estimated pair-wise lift can be computed using predicted usage counts estimated based upon metadata associated a pair of items. For example, when a new song is added to a music library, predicted usage data can be computed based upon metadata associated with the new song (e.g. artist, album, genre, composer, etc.). This predicted usage data can be used to calculate pair-wise lift and generate recommendations where actual usage data is unavailable.

In other aspects, predicted usage data can be combined with actual usage data to compute pair-wise lift and generate item recommendations. When a new item is first introduced, little or no usage data may be available. In which case usage data and pair-wise lift can be predicted based upon metadata for the newly introduced item. Over time, usage data can be collected for the new item, combined with the predicted usage data and incorporated into calculation of the predicted pair-wise lift. Actual usage counts will increase over time, drowning out the predicted counts such that pair-wise lift is eventually based primarily on actual usage.

In further aspects, metadata based predictions of pair-wise lift can be used to develop explanations for item recommendations. Users can better utilize item recommendations if they are able to understand the basis for the recommendation. For example, a user who enjoys a movie primarily because of the performance of a particular actor, would be interested in knowing whether recommendations derived from the first movie are based upon the actor, the director, or some other common feature. By evaluating the effect of various metadata features (e.g. actor, director, genre, screenwriter) on the predicted pair-wise lift for a pair of items, the metadata feature having the largest impact or effect on pair-wise lift can be identified. Explanations of item recommendations can be provided based upon metadata features that have the greatest impact on pair-wise lift. Explanations are independent of recommendation generation and can be used with any recommendation algorithm or method.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system for facilitating generation of item recommendations in accordance with an aspect of the subject matter disclosed herein.

FIG. 2 is a block diagram of a system for prediction of pair-wise lift in accordance with an aspect of the subject matter disclosed herein.

FIG. 3 is a block diagram of an alternative system for prediction of pair-wise lift in accordance with an aspect of the subject matter disclosed herein.

FIG. 4 is a block diagram of a system for training predictive components in accordance with an aspect of the subject matter disclosed herein.

FIG. 5 is a more detailed block diagram of a system for training predictive components in accordance with an aspect of the subject matter disclosed herein.

FIG. 6 is a block diagram of a system for generating item recommendations and explanations in accordance with an aspect of the subject matter disclosed herein.

FIG. 7 is a block diagram of a system for generating an explanation for a recommendation in accordance with an aspect of the subject matter disclosed herein.

FIG. 8 illustrates a methodology for generating recommendations based at least in part upon estimated pair-wise lift in accordance with an aspect of the subject matter disclosed herein.

FIG. 9 illustrates a methodology for estimating pair-wise lift in accordance with an aspect of the subject matter disclosed herein.

FIG. 10 illustrates an alternative methodology for estimating pair-wise lift in accordance with an aspect of the subject matter disclosed herein.

FIG. 11 illustrates a methodology for training a pair-wise lift estimator in accordance with an aspect of the subject matter disclosed herein.

FIG. 12 illustrates a methodology for generating explanations for a recommended list of items in accordance with an aspect of the subject matter disclosed herein.

FIG. 13 illustrates a methodology for generating an explanation for an item pair in accordance with an aspect of the subject matter disclosed herein.

FIG. 14 is a schematic block diagram illustrating a suitable operating environment.

FIG. 15 is a schematic block diagram of a sample-computing environment.

### DETAILED DESCRIPTION

The various aspects of the subject matter disclosed herein are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer, a hand-held computing device (e.g., personal digital assistant (PDA), phone, watch), a microprocessor-based or programmable consumer or industrial electronic device (e.g. personal media players, digital video recorders, video game systems) and the like. By way of illustration, both an application running on computer and the computer can be a component. One or more components may reside within a process and/or thread of execution and a component may be localized on one computer and/or distributed between two or more computers.

The word “exemplary” is used herein to mean serving as an example, instance, or illustration. The subject matter disclosed herein is not limited by such examples. In addition, any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Typically, collaborative filtering recommendation systems rely upon usage patterns in generating item recommendations. In particular, such recommendation systems can calculate pair-wise lift to predict the increase in probability that a user will enjoy an item based upon the user's enjoyment of a previous item. Pair-wise lift is a measurement of the correlation between a pair of items and can be calculated based upon usage counts for the pairs of items. Pair-wise lift, also referred to herein as lift, can be expressed using the following exemplary equation:

$$Lift ( b -> c ) = \frac{p ( c = 1 \text{\textbar} b = 1 )}{p ( c = 1 )}$$

Here, the lift or increased probability of a target or candidate item c, given a source or base item b, is the probability that c occurs given that b occurs, divided by the marginal probability that c occurs. Lift reflects how much more likely it is that c occurs given that b occurs, compared to how likely it is that c occurs when there is no additional knowledge regarding b. The higher the lift, the more likely it is that a user who bought, liked and/or used item b will buy, like and/or use item c.

In an example, pair-wise lift can be used in a music recommendation system. Here, pair-wise lift measures the increase in probability over a baseline probability that users will like a new album, given that the user enjoyed a previous album. The baseline probability is the probability that a user will enjoy the new album, whether or not the user has enjoyed any other albums. For example, if there were a five-percent chance that any given user will enjoy the new album, and a ten-percent chance that a user who has enjoyed a previous album by the artist will enjoy the new album, the calculated lift would be equal to two. The user who has enjoyed the previous album is twice as likely to enjoy the new album.

Pair-wise lift can be calculated based upon usage counts for a pair of items. Statistics or counts of the actual usage of the item can be collected and maintained. As used herein, usage counts or data can track or monitor actual usage for pairs of items: how many users liked both items; how many users liked the first item, but not the second item; how many users liked the second item, but not the first item; and how many users did not like either item. Lift can be computed based upon usage counts using the following exemplary equation:

$$Lift ( b -> c ) = \frac{PWC ( b = 1 , c = 1 )}{PC ( b = 1 ) PC ( c = 1 )} {\#}_{users}$$

Here, PWC(b=1, c=1) is the pair-wise or co-occurrence count of items b and c, where the pair-wise count indicates that both items are used or selected. For example, if b is the television show “The Simpsons” and c is the television show “Futurama,” the pair-wise count for the b and c would be the number of users who watched both “The Simpsons” and “Futurama.” PC(b=1) and PC(c=1) are the popularity or occurrence counts for items b and c, where a popularity or occurrence count is equal to the number of users who selected, bought or otherwise used an item. For example, the popularity count for b, “The Simpsons,” is equal to the number of users who watched “The Simpsons,” regardless of what else the user watched.

The calculation of pair-wise lift is typically dependent upon availability of usage data or counts. Lack of usage data for new items is sometimes referred to as the cold start problem. If either the base or candidate item is new, there may not be sufficient usage data to reliably compute lift. Accordingly, a recommendation system based on pair-wise lift will be unable to make reliable recommendations regarding new items. Unfortunately, it is recommendations with respect to newly available items that are most likely to be particularly helpful to users.

Pair-wise lift based recommendation systems may also have difficulty where the number of actual usage counts collected is relatively low compared to the number of items available. If the number of items is vast (e.g., an online music library), not every pair of items may co-occur frequently within the usage counts. The recommendation system can have difficulty generating suggestions even for old items if there is insufficient usage data for items in general.

The lack of actual usage data can be offset or mitigated using metadata associated with base and candidate items to predict pair-wise lift for item pairs. For example, if a user enjoys a heavy metal album, there is an increased probability that the user will enjoy a second heavy metal album, rather than a classical music album. These metadata relationships can be modeled and one or more trained models can be used to predict lift based upon metadata (e.g., genre, actor, writers). Models can predict popularity and pair-wise counts, replacing actual usage counts used in the equation above to compute pair-wise lift.

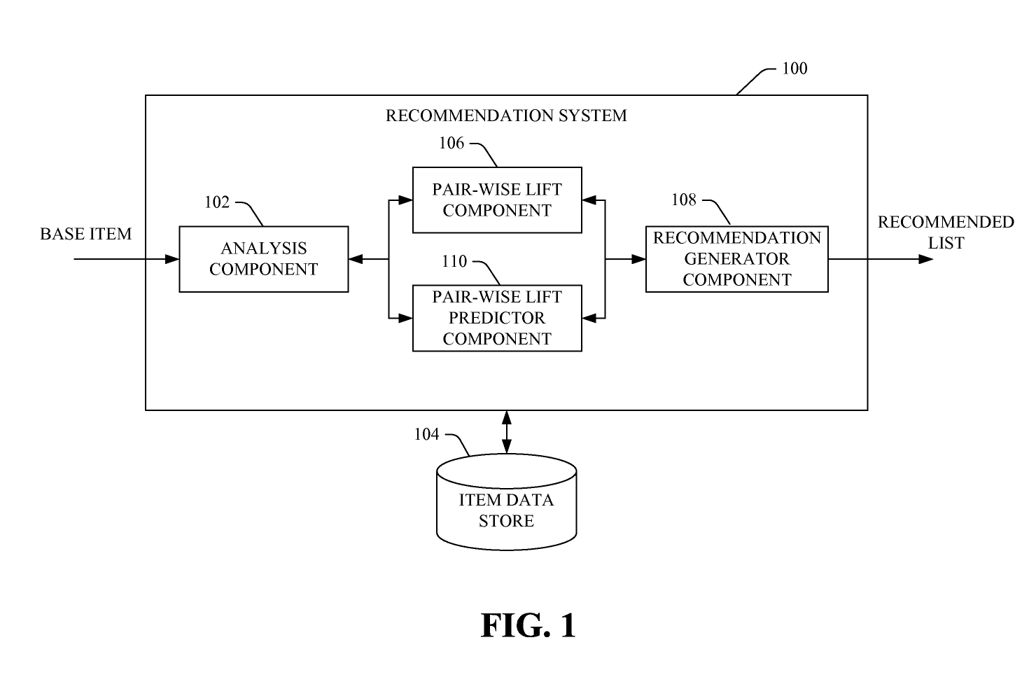

Referring now to FIG. 1, a system for facilitating generation of lists of recommended items is illustrated. A recommendation system 100 can generate one or more item recommendations based upon information regarding a selected item, referred to herein as the base or seed item. Recommended items can be provided to a user interface (not shown) for presentation to a user. The recommendation system 100 can include an analysis component 102 that obtains or receives information regarding the base item as well as any potential recommended items, referred to herein as candidate items. The analysis component 102 can access an item data store 104 to locate base item and candidate item information for use in facilitating production of a recommended list. As used herein, a data store is any collection of data, such as a library, a database or the like.

Items can be any person, place or thing, where there is a correlation between pairs of items. Items may be, for example, songs, music videos, movies, documents, books, poems, images, television shows, web pages, dating prospects, products and the like. The items may be described by identifying information or metadata including, but not limited to, the name of the item (e.g., song title, movie title, television show title), the performer (e.g., artist, actors) and author (e.g., composer, writer, photographer). The metadata can also include descriptive information that characterizes the item. For example, for a song item, metadata can include information concerning the genre of the song (e.g., folk, jazz, new wave) and the mood of the song (e.g., soothing, lonely, wild). Similarly, for a television program item metadata can include format (e.g., series, miniseries, movie) and category (e.g., comedy, drama, documentary).

The item data store 104 can maintain metadata and usage data for a set of items. Usage data includes any information indicative of item utility, desirability and/or user preferences with respect to items including explicit feedback such as ratings (e.g., thumbs up or thumbs down, one through five stars), rankings, user comments and the like. Usage data can also include popularity counts for items (e.g., users who selected or used each item individually) and co-occurrence counts for pairs of items (e.g., users who selected or used each of the pair of items). Usage information can be maintained within the item data store 104 or maintained in a separate usage data store (not shown). Usage data can be gathered by monitoring and logging user actions and/or selections over time. The analysis component 102 can provide the item information and usage count information to a pair-wise lift component 106 that can calculate lift based upon the usage data and provide lift to a recommendation generator component 108. The recommendation generator component 108 can utilize lift for item pairs to select one or more candidate items for recommendation. The recommendation generator component 108 can assemble and format a set of item recommendations for provision to a user interface and presentation to a user.

However, as described above, items newly added to the item data store 104 may lack sufficient usage count information for computation of pair-wise lift by the pair-wise lift component 106. If the analysis component 102 determines that insufficient usage count information is available for a pair of items, the base item, the candidate item and their associated metadata can be entered as input to the pair-wise lift predictor component 110. The pair-wise lift predictor component 110 can predict lift the item pair based at least in part upon the metadata associated with the items. This predicted lift can be provided to the recommendation generator component 108 in place of pair-wise lift computed using usage data and used in generation of item recommendations.

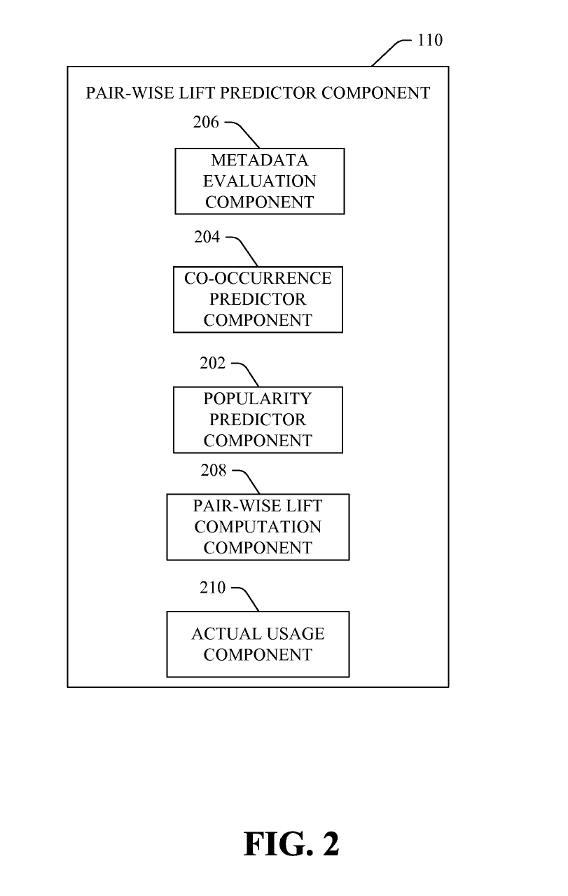

Referring now to FIG. 2, a system for prediction of pair-wise lift is illustrated. The pair-wise lift predictor component 110 utilizes metadata to predict popularity counts for each item of the item pair and co-occurrence counts for the item pair. These predicted counts can be used to compute the predicted pair-wise lift for the item pair. The pair-wise predictor component 110 can include a popularity predictor component 202 capable of predicting the popularity or occurrence count for an item based upon item metadata. The pair-wise predictor component 110 can also include a co-occurrence predictor component 204 capable of predicting co-occurrence or pair-wise counts for a pair of items based upon the metadata of the pair items.

One or both of the co-occurrence predictor component 204 and the popularity predictor component 202 can utilize a conditional model such as a logistic regression model to predict popularity and co-occurrence counts. In general, logistic regression models can be used to predict the probability of a binary output variable based on values of binary input variables. For example, the probability of a binary output variable y based on the values of n binary input variables x₁, . . . , xᵢ, . . . , xₙ can be represented by the following equation:

$$p ( y ) = \{ \begin{matrix}\frac{{e}^{{w}_{0} + {\sum }_{i = 1}^{n} {w}_{i} {x}_{i}}}{1 + {e}^{{w}_{0} + {\sum }_{i = 1}^{n} {w}_{i} {x}_{i}}} , y = 1 \\ \frac{1}{1 + {e}^{{w}_{0} + {\sum }_{i = 1}^{n} {w}_{i} {x}_{i}}} , y = 0\end{matrix}$$

where w₀ is a bias weight and w₁, . . . , wᵢ, . . . , wₙ are a set of model weights associated with the input variables. Popularity or co-occurrence can be expressed as probability of y based upon inputs x and model weights, w, or p(y|x,w). Logistic regression models can be implemented using a single layer neural network with a single output node. The output activation of the neural network can be interpreted as a probability of occurrence or co-occurrence.

The popularity predictor component 202 can utilize a logistic regression model to predict popularity. For popularity prediction, output y indicates whether a user uses, likes or buys the item (e.g., 1 indicates the user purchase the item, 0 indicates the user does not purchase the item). The input variables, x₁, . . . , xᵢ, . . . , xₙ, are binary values that represent metadata associated with an item. Model weights, w₁, . . . , wᵢ, . . . , wₙ, are generated when the logistic regression model is trained, as discussed in further detail below.

A metadata evaluation component 206 can evaluate or analyze metadata associated with items and reformat or prepare the metadata as needed for use by popularity or co-occurrence predictor components 202, 204. For example, the metadata should be represented in binary form for use with a logistic regression model. Each input, xᵢ, can be a binary variable corresponding to a metadata feature of an item. For example, for metadata associated with a television program, input variable x₁ can indicate whether the program is a movie, input variable x₂ can indicate whether the program is a series, input variable x₃ can indicate whether Sean Connery appears in the program and so forth. An exemplary set of metadata input variables for the television program “The Simpsons” follows:

| | |
|---|---|
| Category is Movies | 0 |
| Category is Series | 1 |
| Category is Series/Action/Adventure | 0 |
| Category is Series/Comedy | 1 |
| Actor is Dan Castellaneta | 1 |
| Actor is Sean Connery | 0 |
| Actor is Yeardley Smith | 1 |

Typically, the number of inputs that are non-zero, referred to as active inputs, are small in comparison to the total number of input variables. The metadata evaluation component 206 can analyze provided metadata and generate input variables for logistic regression models. Alternatively, metadata can be provided to the pair-wise lift predictor component 110 formatted and ready for use by the popularity and co-occurrence predictor components 202, 204.

Once the model is trained, the popularity component can utilize the metadata associated with an item to predict the percentage of users that will utilize the item. The predicted percentage can be multiplied by the size of a user base to generate a predicted popularity count. This predicted popularity count can be utilized in place of actual usage counts.

The co-occurrence predictor component 204 can also utilize a logistic regression model to predict co-occurrence of pairs of items. Here, the output variable y is the probability that a user will like, use, or buy both items. Multiple types of input variables can be utilized for co-occurrence prediction, including value inputs and type inputs. Value inputs correspond to direct matching of metadata features for a pair of items. For example, if the pair of items includes the television program “The Simpsons” and the television program “Futurama”, an exemplary list of value input variables can include:

| | |
|---|---|
| Category is Movies | 0 |
| Category is Series/Comedy | 1 |
| Actor is Dan Castellaneta | 0 |
| Executive Producer is Matt Groening | 1 |

While both items are categorized as a “Series/Comedy,” input variable “Actor is Dan Castellaneta” would be inactive because the actor works on only one of the two shows. However, the input variable for “Executive Producer is Matt Groening” is active because Matt Groening is an Executive Producer on both shows.

Type inputs indicate a match in a kind or type of metadata rather than a match for a particular value of metadata. For example, type input variables for television programs can include Categories, Actors, and Executive Producers. Continuing the example above, an exemplary list of type input variables can include:

| | |
|---|---|
| Category Matches | 1 |
| Actor Matches | 0 |
| Executive Producer Matches | 1 |

Here, input variable “Category Matches” is active, indicating that the television programs have at least one category in common, input variable “Actor Matches” is inactive, indicating that the programs have no actors in common and input variable “Executive Producer Matches” is active, indicating that the programs share at least one executive producer.

Type input variables can be particularly useful when items with novel metadata are to be evaluated. For example, two movies directed by the same new, young director can be added to the item data store. Even if there are no preexisting movies with the same director, the co-occurrence model can still represent the relationship between the two new movies. Accordingly, the co-occurrence predictor component 204 is able to leverage new metadata in generating predictions.

Possible input variables are not limited to type and value input variables. Additional categories of input variables can be utilized to represent metadata relationships. An input variable can be defined that is active whenever a particular individual is involved in a television program regardless of the individual's specific role. For example, the input variable “Quentin Tarrantino appears in credits” can be active regardless of whether Mr. Tarrantino appears as a director, actor, producers or the like. Similarly, variables can be defined to reflect known relationships between individual metadata features. For example, if it is known that users that enjoy Sean Connery's movies are more likely to enjoy movies in which Roger Moore appears, an input variable can be defined to reflect this relationship. Input variable “Actor is Sean Connery; Actor is Roger Moore” can be active if Sean Connery appears in one item, while Roger Moore appears in the other item.

Once a co-occurrence model is trained, the co-occurrence predictor component 204 can utilize metadata associated with a pair of items to predict the percentage users that will utilize both items. The predicted percentage can be multiplied by the size of the user base to generate a predicted co-occurrence count. The predicted co-occurrence count can be used in place of actual usage counts.

The pair-wise lift computation component 208 can generate the predicted pair-wise lift based upon the count predictions. More particularly, the pair-wise lift computation component 208 can utilize the predicted popularity count for the candidate item, the predicted popularity count for the base item and the predicted co-occurrence count for the item pair to calculate lift. The predicted pair-wise lift can be provided to a recommendation system for use in generating a recommendation list.

The pair-wise lift computation component 208 can also correct for any inconsistency between the predicted popularity counts and predicted co-occurrence count. If the predicted popularity counts and predicted co-occurrence count are generated utilizing separate models, the predictions can be inconsistent. Because the models are independent, it is possible for a predicted popularity count for an item to be less than the predicted co-occurrence count for the item pair. For example, nine hundred users can be predicted to watch a first television program, while one thousand users can be predicted to watch both the first and a second television program. The pair-wise lift computation component 208 can correct such inconsistencies by ensuring that the predicted co-occurrence count is always less than or equal to the corresponding popularity count.

The pair-wise lift computation component 208 can also generate pair-wise lift based upon a combination of predicted counts and actual usage data. The pair-wise predictor component 110 can include an actual usage component 210 that can obtain any available usage data. The available usage data can be combined with the predicted counts to generate lift. Here, the predicted counts can be used to supplement the actual counts where there is insufficient data to reliably generate pair-wise lift. As the number of actual counts increases over time, actual accounts will eventually outnumber predicted counts. Eventually, predicted counts will constitute only a small fraction of total counts used to generate pair-wise lift. In this manner, the pair-wise lift computation component can move smoothly from computing pair-wise lift based solely on predicted to counts to computing pair-wise lift based primarily upon actual usage counts.

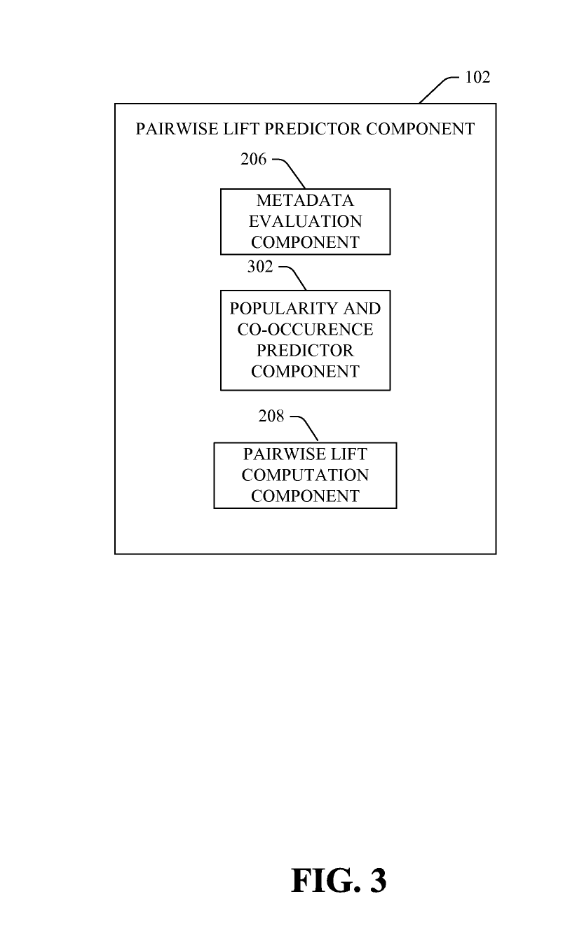

Referring now to FIG. 3, an alternative system for prediction of pair-wise lift is illustrated. The pair-wise lift predictor component 110 can include a popularity and co-occurrence predictor component 302 capable of predicting both popularity counts and co-occurrence counts for item pairs. The popularity and co-occurrence predictor component 302 can utilize a single, joint model that predicts both popularity counts and co-occurrence counts. Prediction of both popularity and co-occurrence for a pair of items is equivalent to determining the probability for each of the four possible states for an item pair, user utilizes: i) neither item, ii) both items, iii) only the first item or iv) only the second item. These probabilities can be expressed as p(y₁, y₂):

$$p ( {y}_{1} , {y}_{2} ) = \{ \begin{matrix}\frac{1}{c} & if {y}_{1} = 0 , {y}_{2} = 0 \\ \frac{1}{c} {e}^{{w}_{0} + {\sum }_{i = 1}^{n} {w}_{i} {x}_{i}^{( 1 )}} & if {y}_{1} = 1 , {y}_{2} = 0 \\ \frac{1}{c} {e}^{{w}_{0} + {\sum }_{i = 1}^{n} {w}_{i} {x}_{i}^{( 2 )}} & if {y}_{1} = 0 , {y}_{2} = 1 \\ \frac{1}{c} {e}^{2 {w}_{0} + {\sum }_{i = 1}^{n} {w}_{i} ( {x}_{i}^{( 1 )} + {x}_{i}^{( 2 )} ) + {v}_{0} + {\sum }_{i = 1}^{m} {v}_{i} {x}_{i}^{( 12 )}} & if {y}_{1} = 1 , {y}_{2} = 1\end{matrix}$$

Here, y₁ indicates whether the first item is selected and y₂ indicates whether the second item is selected. A constant, c, is chosen such that the probability p(y₁, y₂) sums to 1 over the four possible states of the model. The input variables xᵢ⁽¹⁾ and xᵢ⁽²⁾ are popularity inputs for the first and second items, respectively, while input variables xᵢ⁽¹²⁾ are co-occurrence inputs for the first and second items. A shared bias weight, w₀, and set of popularity weights, w₁, . . . , wₙ, are used for the popularity inputs of both shows. A separate bias weight, v₀, and set of co-occurrence weights, vᵢ, . . . vₙ, are utilized for the co-occurrence of the items.

The four states or probabilities of the joint model can be used to estimate the popularity for each item and co-occurrence probabilities for the item pair. The probability of both shows being selected, p(1, 1) is the co-occurrence probability. The popularity probability for item 1 is the sum of the probability of both shows being selected and the probability that only item 1 is selected, p(1,1) +p(1,0). Similarly, popularity probability for item 2 is the sum of the probability of both shows being selected and the probability that only item 2 is selected, p(1,1) +p(0,1). These probabilities can be multiplied by a user base to generate predicted popularity and co-occurrence counts that can be used by the pair-wise lift computation component 208 to generate predicted lift.

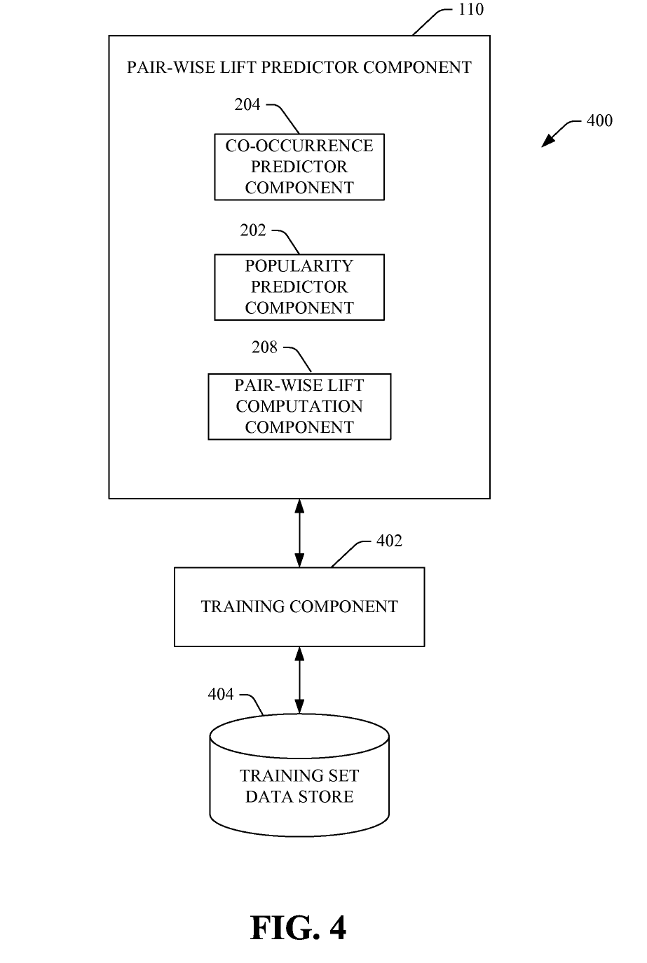

Referring now to FIG. 4, a system 400 for training popularity and co-occurrence predictor components 202, 204 is illustrated. The popularity and co-occurrence prediction components 202, 204 can utilize learned models, trained by a training component 402 based upon user data maintained in a training set data store 404. In particular, if the popularity and co-occurrence prediction components 202, 204 utilize logistic regression models, logged user data can be utilized to generate the model weights discussed above. The models can be trained and the model weights can be generated by minimizing a cost function, as discussed in detail below.

The logged user data maintained in the training set data store 404 can be represented by popularity and co-occurrence data tables. An exemplary popularity data table is provided below in Table I.

TABLE I

| Item Id | User Id | X₁ | X₂ | X₃ | . . . | Xₙ | Item was seen (y) |
|---|---|---|---|---|---|---|---|
| 1 | 1 | 1 | 1 | 0 | . . . | 1 | 1 |
| 1 | 2 | 1 | 1 | 0 | . . . | 1 | 0 |
| 1 | 3 | 1 | 1 | 0 | . . . | 1 | 0 |
| 2 | 1 | 0 | 0 | 1 | . . . | 1 | 1 |
| 2 | 2 | 0 | 0 | 1 | . . . | 1 | 1 |
| 2 | 3 | 0 | 0 | 1 | . . . | 1 | 1 |
| 3 | 1 | 1 | 1 | 1 | . . . | 0 | 0 |
| 3 | 2 | 1 | 1 | 1 | . . . | 0 | 1 |
| 3 | 3 | 1 | 1 | 1 | . . . | 0 | 1 |

For each item Table I includes a separate row corresponding to every user. Input variables are represented by X₁ through Xₙ and the column labeled “Item was seen” indicates whether the particular user selected or viewed the item. For Table I, three items, three users and n different input variables are depicted.

A co-occurrence data table corresponding to Table I is illustrated below in Table II.

TABLE II

| Item 1 | Item 2 | User Id | X₁ | X₂ | X₃ | . . . | Xₙ | Pair was seen (y) |
|---|---|---|---|---|---|---|---|---|
| 1 | 2 | 1 | 1 | 1 | 0 | . . . | 1 | 1 |
| 1 | 2 | 2 | 1 | 1 | 0 | . . . | 1 | 0 |
| 1 | 2 | 3 | 1 | 1 | 0 | . . . | 1 | 0 |
| 1 | 3 | 1 | 0 | 0 | 1 | . . . | 1 | 0 |
| 1 | 3 | 2 | 0 | 0 | 1 | . . . | 1 | 1 |
| 1 | 3 | 3 | 0 | 0 | 1 | . . . | 1 | 0 |
| 2 | 3 | 1 | 1 | 1 | 0 | . . . | 0 | 0 |
| 2 | 3 | 2 | 1 | 1 | 0 | . . . | 0 | 1 |
| 2 | 3 | 3 | 1 | 1 | 0 | . . . | 0 | 1 |

In Table II, for every item pair, there is a separate row corresponding to every user. The input variable columns, X₁, . . . , Xₙ, are active if the pair of items matches and the column labeled “Pair was seen” indicates whether the pair of items was seen by the user.

A cost function can be used with the popularity or co-occurrence data tables to determine model weights. An exemplary penalized likelihood cost function, can be represented by:

$$Cost ( w ) = - {\sum }_{r}^{ } log ( p ( y ( r ) \text{\textbar} x ( r ) , w ) ) + α {‖ w ‖}^{2}$$

Here, the cost is computed as the sum over all rows, r, of the table; y(r) is the output value of row r indicating that the item or pair was seen; and x(r) is a vector generated by the set of values from all the input variable columns, X₁, . . . , Xₙ, in row r. The first term of the cost function, log(p(y(r)|x(r),w)) decreases as p(y|x(r),w) comes closer to matching the proportion of the active output in the rows with the same input as row r. The second term of the cost function penalizes weights, w, that become excessive and rely too heavily on the training data. This phenomenon, known in the art as “over-fitting” causes the models to fail to generalize well to examples not seen in the training data. A constant, α, can be set to control the trade-off between matching the training data and generalizing well to previously unseen examples. The weights, w, can be trained by minimizing the cost function. Because the cost function is a smooth function of the weights, many generic optimization algorithms can be utilized for training of weights (e.g., gradient descent, conjugate gradient descent, simplex search).

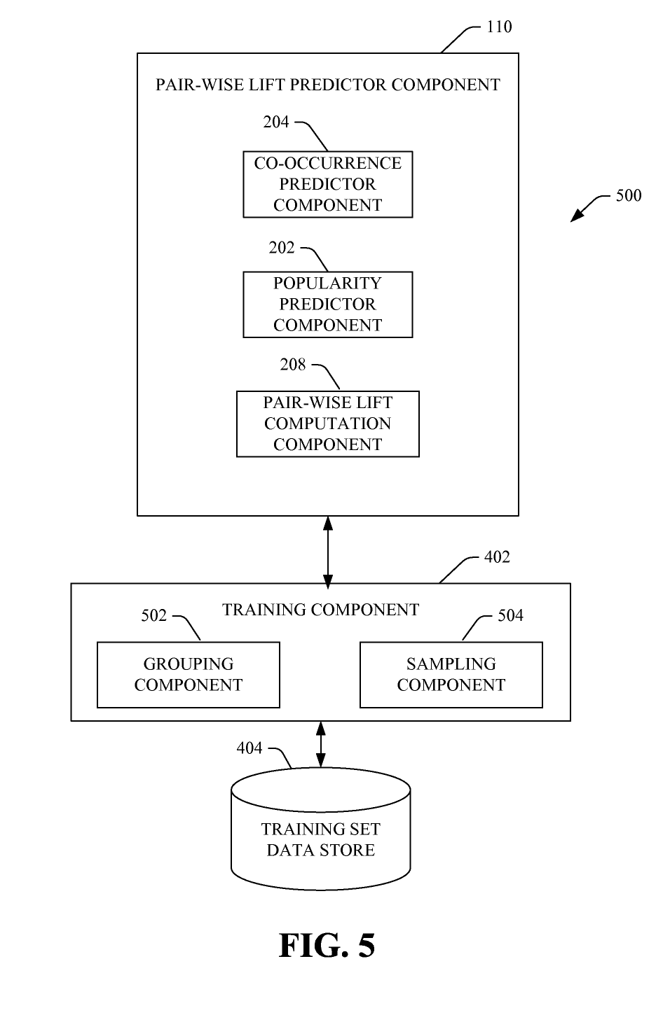

Referring now to FIG. 5, an alternative training system 500 is illustrated. Popularity and co-occurrence data tables can become extremely large as new items, users and input variables are added. The training component 402 can include a grouping component 502 and a sampling component 504 to reduce data requirements for training of predictive models used by popularity and co-occurrence predictor components 202, 204.

The grouping component 502 can reduce data storage requirements by grouping or combining usage data for multiple users. For example, instead of maintaining a separate row for each user, the popularity and co-occurrence data tables depicted above can be rewritten to show only the total number of users for each item. For example, Table III corresponds to the popularity data table of Table I.

TABLE III

| Item Id | X₁ | X₂ | X₃ | . . . | Xₙ | item was seen (y) |
|---|---|---|---|---|---|---|
| 1 | 1 | 1 | 0 | . . . | 1 | 1 |
| 2 | 0 | 0 | 1 | . . . | 1 | 3 |
| 3 | 1 | 1 | 1 | . . . | 0 | 2 |

In Table III, a single row is required for each item, greatly reducing the total size of the data table. The co-occurrence table illustrated in Table II can also be rewritten by grouping users, as illustrated in Table IV.

TABLE IV

| Item 1 | Item 2 | X₁ | X₂ | X₃ | . . . | Xₙ | pair was seen (y) |
|---|---|---|---|---|---|---|---|
| 1 | 2 | 1 | 1 | 0 | . . . | 1 | 1 |
| 1 | 3 | 0 | 0 | 1 | . . . | 1 | 1 |
| 2 | 3 | 1 | 1 | 0 | . . . | 0 | 2 |

### For Table IV, a single row corresponds to a pair of items, reducing the total size of the data table.

The cost function can be modified to provide for grouping of users as follows:

$$Cost ( w ) = - {\sum }_{i}^{ } {\sum }_{u}^{ } log ( p ( y ( i , u ) \text{\textbar} x ( i ) , w ) ) + α {‖ w ‖}^{2}$$

Instead of a sum over the data table rows, the cost function now includes an explicit inner and outer sum. The values y(r) and x(r) are replaced by y(i,u) and x(i) because data table rows can now be indexed by item and user. The cost function can be re-written as:

$$Cost ( w ) = - {\sum }_{i}^{ } [ {\#}_{0} ( i ) log ( p ( 0 \text{\textbar} x ( i ) , w ) ) + {\#}_{1} ( i ) log ( p ( 1 \text{\textbar} x ( i ) , w ) ) ] + α {‖ w ‖}^{2}$$

Here, #₀(i) and #₁(i) are the number of users (rows with item i) with y=0 and y=1, respectively. Instead of requiring a data table with a total number of rows equal to the number items multiplied by the number of users, the total number of rows can be equal to the number of items, since #₀(i) and #₁(i) sum to the number of users. Accordingly, only a single count of total users can be maintained, rather than a separate record for each individual user.

The training component can also include a sampling component 504 capable of reducing data storage requirements by sampling the usage data of the training set. For many environments (e.g., television programming), most of the vast number of users will not have selected or used a given item. This is reflected in the usage tables, where the great majority of rows have y=0, indicating that the item or item pair was not seen. Data where the item is not seen can be sampled to reduce the total volume of data stored. For the data tables, the rows where the y is equal to zero can be randomly sampled, maintaining only a fraction, or proportion of such rows. The probability based upon the sampled data can be expressed as pₛ(y|x,w). Once the models have been trained based upon the sampled data, the probabilities generated using the models should be multiplied by the sampling factor, θ, to adjust for sampled training. The sampling factor can be applied as shown in the exemplary probability equation:

$$p ( y ) = \{ \begin{matrix}\frac{θ {p}_{s} ( 1 )}{{p}_{s} ( 0 ) + θ {p}_{s} ( 1 )} , y = 1 \\ \frac{{p}_{s} ( 0 )}{{p}_{s} ( 0 ) + θ {p}_{s} ( 1 )} , y = 0\end{matrix}$$

### In particular, the sampling factor can be selected such that the total number rows where an item or item pair was used, y=1, is approximately equal to the total number of rows, where items or item pairs were not used, y=0.

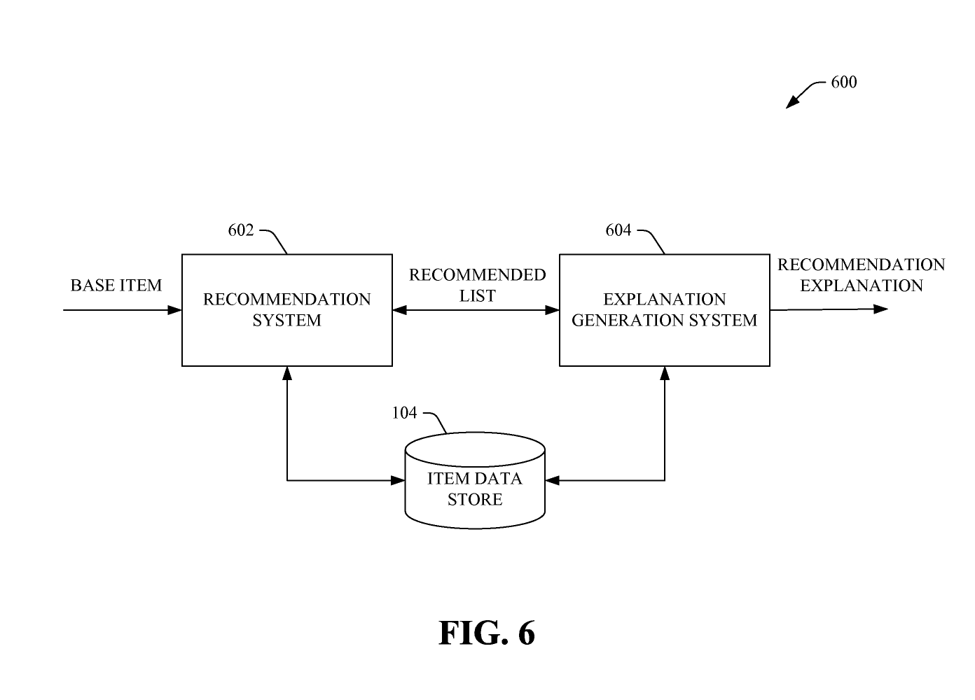

Turning now to FIG. 6, a system 600 for generating recommendations and explanations is illustrated. Explanations for recommendations can be invaluable to users in identifying relevant or desired items from a set of recommended items. A user who has enjoyed an item based upon a particular feature may want to know whether a new item has been recommended based upon the particular feature, or whether the item was recommended based upon other common metadata. For example, a James Bond fan may choose to watch “On Her Majesty's Secret Service.” Using that movie selection as a base item, an automatic recommendation system might recommend “The Kentucky Fried Movie” to the user because actor George Lazenby appears in both movies. The Bond fan can disregard the recommendation if the explanation states that the second movie was suggested based upon actors. Moreover, users are more likely to have confidence in a recommendation system that is able to explain seemingly incongruous recommendations. If users are unaware of the metadata features used to make a recommendation, or focused on other features, they may be confused by the item recommendations and become frustrated with the recommendation system.

The system 600 includes a recommendation system 602 that utilizes item information maintained in an item data store 104 to generate a set of one or more recommended items. The recommendation system 602 can utilize pair-wise lift as described above, or any other method for generating the recommended list. The set of recommended items and the base item utilized to generate the set can be provided to an explanation generation system 604. Alternatively, the recommendation system 602 can include the explanation generation system 604. The explanation generation system 604 can utilize the set of recommended items, the base item and metadata obtained from the item data store 104 to generate explanations for items within the set of recommended items. These explanations can be provided to a user interface (not shown) for presentation to a user. The explanations can be provided in any suitable format, including natural language text strings.

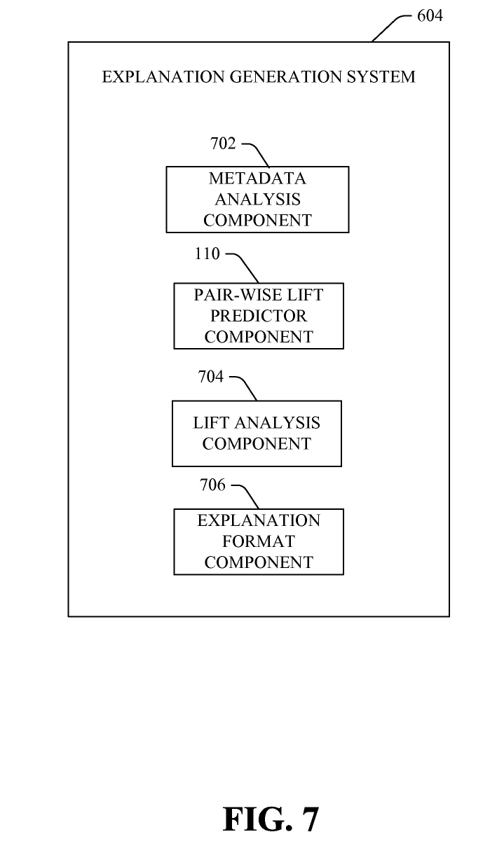

Referring now to FIG. 7, a system for generating explanations is illustrated. The explanation generation system 604 can analyze each item within a set of recommended items. An explanation for an item recommendation can be based upon metadata associated with the item and the effect or impact the metadata has on predicted pair-wise lift. The metadata for an item can be evaluated to determine which metadata feature associated with the recommended item has the greatest impact upon pair-wise lift. The metadata feature with the largest impact can be considered to best explain the item recommendation.

The explanation generation system 604 can include a metadata analysis component 702 that obtains and analyzes metadata for a base item and a recommended item. The metadata analysis component 702 can determine the common metadata features for the item pair. Each common metadata feature can be independently evaluated to determine relative impact of the features upon pair-wise lift. The metadata feature that generates the larges impact is most likely to account for recommendation of the item.

A pair-wise predictor component 110, such as the component described with respect to FIGS. 1 and 2, can be used to generate an estimated pair-wise lift for the pair of items. Subsequently, additional lifts can be generated, where a common metadata feature is eliminated from the lift calculation each time. In this manner, the impact of each individual piece of metadata can be effectively measured as a function of estimated pair-wise lift.

A lift analysis component 704 can evaluate the various lift values generated based upon the varying metadata features and determine the metadata feature most likely to have caused the recommended item to be presented to users. The explanation format component 706 can generate an explanation based upon the effects of the metadata. The explanation can be formatted in any suitable manner. For example, the explanation can be provided in a natural language text string for use by a user interface (not shown).

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Additionally, it should be noted that one or more components may be combined into a single component providing aggregate functionality or divided into several sub-components. The components may also interact with one or more other components not specifically described herein but known by those of skill in the art.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

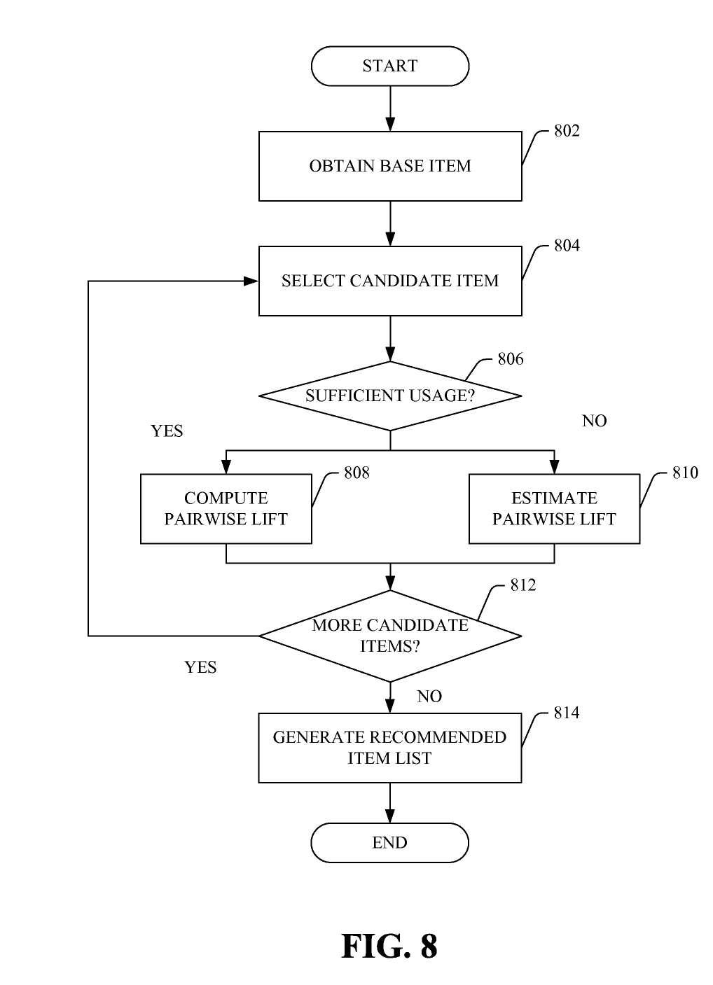

Referring now to FIGS. 8-13, while for purposes of simplicity of explanation, the methodologies that can be implemented in accordance with the disclosed subject matter were shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

Referring now to FIG. 8, a methodology for generating recommendations based at least in part upon estimated pair-wise lift is illustrated. At 802, a base item upon which the recommendations will be made is obtained. A candidate item is selected at 804. Typically, the selected candidate item is obtained from a set of available items to be evaluated for recommendation. At 806, a determination is made as to whether there is sufficient usage data or usage counts for the candidate item and/or the base item to compute pair-wise lift based solely upon actual usage data. If there is a sufficient amount of usage data, pair-wise lift can be computed based upon usage counts at 808. However, if there is insufficient usage information (e.g., the candidate item was recently added to the library of items), the pair-wise lift can be predicted or estimated based upon base item and candidate item metadata at 810. At 812, determination is made as to whether there are additional candidate items to evaluate. If yes, the process returns to 804 where the next candidate item is selected. If no, one or more candidate items are selected for recommendation based at least in part upon the pair-wise lift values computed and/or estimated for the candidate items at 814. Larger pair-wise lift values indicate greater increases in probability of the candidate item based upon the base item. Consequently, items with the largest pair-wise lift are generally selected for inclusion in a recommended item list.

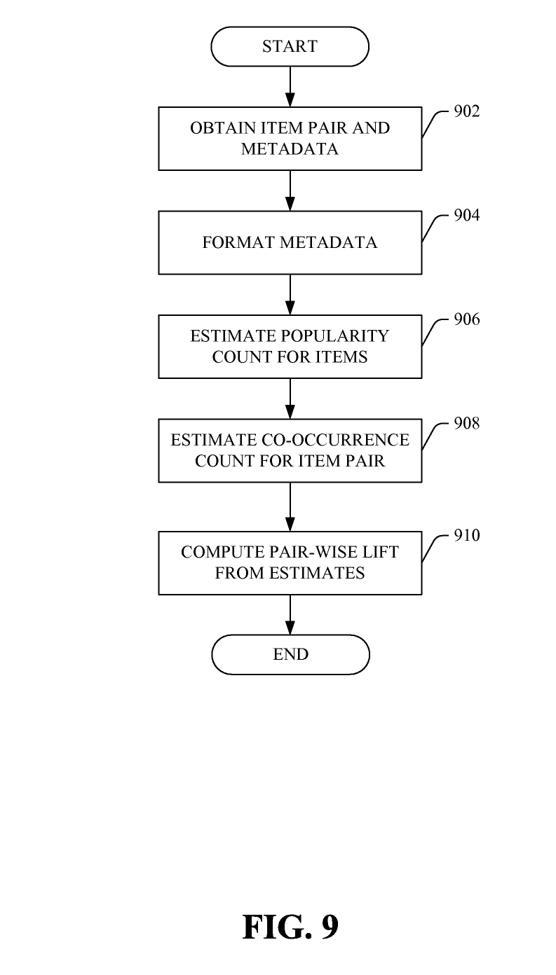

FIG. 9 illustrates a methodology for estimating pair-wise lift based upon metadata. At 902, an item pair and associated metadata are obtained. The metadata can be provided with the base item and candidate item or retrieved separately. The metadata can be evaluated and reformatted, as needed, at 904. For example, metadata can be reformatted as binary values for use with conditional models (e.g., logistic regression models). At 906, popularity counts can be estimated for the base item and candidate item as a function of the metadata. More particularly, the probability of use of each item can be predicted using a logistic regression model. The probability can be multiplied by a base use count to generate an estimated popularity count for each item. At 908, a co-occurrence count for the item pair can be estimated as a function of the metadata. In particular, the probability of use of both items can be predicted using a logistic regression model. The probability of co-occurrence can be multiplied by a base use count to generate an estimated co-occurrence count. Alternatively, popularity and co-occurrence counts can be estimated using a single, joint logistic regression model. At 910, the estimated popularity and co-occurrence counts can be used to compute an estimated pair-wise lift for the item pair.

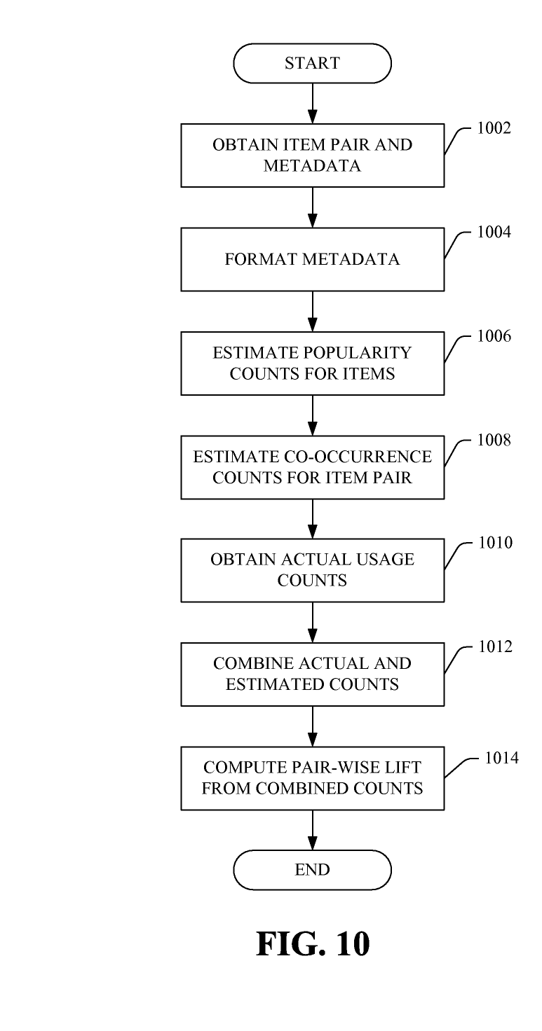

Referring now to FIG. 10, an alternative methodology of estimating pair-wise lift based upon metadata is illustrated. If usage counts for the base item and candidate item are available, but insufficient to reliably compute pair-wise lift, actual usage counts can be combined with estimated popularity and co-occurrence counts for computation of pair-wise lift. At 1002, an item pair and associated metadata are obtained. The metadata can be evaluated and reformatted, as needed, at 1004. For example, metadata can be formatted as binary values for use in logistic regression models. At 1006, popularity counts can be estimated for the base item and candidate item as a function of the metadata. At 1008, co-occurrence counts can be estimated for the item pair as a function of metadata. At 1010, actual usage counts for the base item and candidate item can be obtained. The actual usage counts can be added to the popularity counts and co-occurrence counts at 1012. At 1014, pair-wise lift can be estimated using the combined actual usage counts and the estimated popularity and co-occurrence counts. Over time, as the number of actual usage counts increases, the estimated counts will be drowned out, moving smoothly from pair-wise lift based primarily on metadata to pair-wise lift based upon actual usage data.

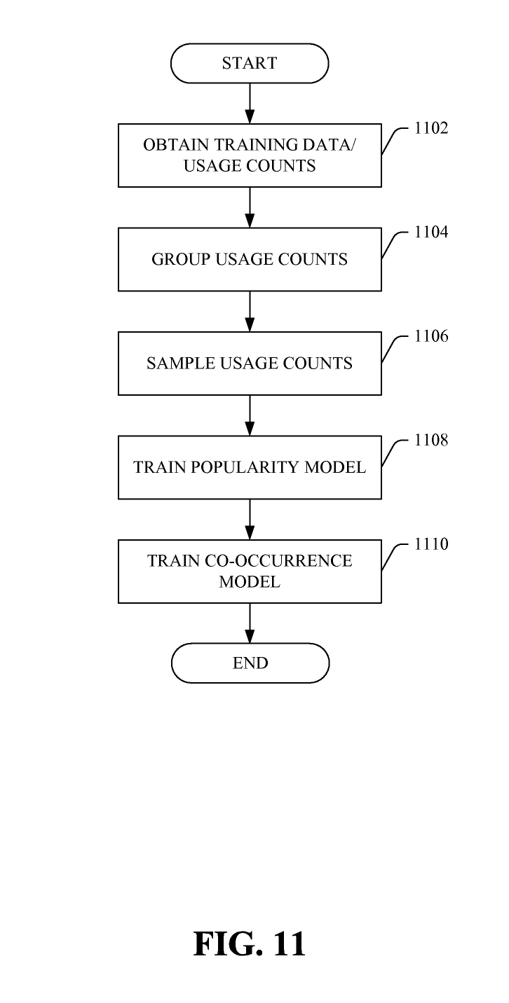

Referring now to FIG. 11, a methodology for training a pair-wise lift estimator is illustrated. A pair-wise lift estimator or predictor may require training prior to use in generating recommendations. At 1102, training data including usage counts can be obtained. Usage counts can be grouped by item or pair of item to reduce the volume of data required at 1104. At 1106, the usage counts where the item or item pair was not selected can be sampled to reduce data volume and enhance the effectiveness of training. The sampled and grouped popularity or occurrence usage data can be utilized to train a popularity model at 1108. Similarly, the sampled and grouped co-occurrence usage data can be utilized to train a co-occurrence model at 1110. Alternatively, a single joint popularity and co-occurrence model can be trained based upon the sampled and grouped data.

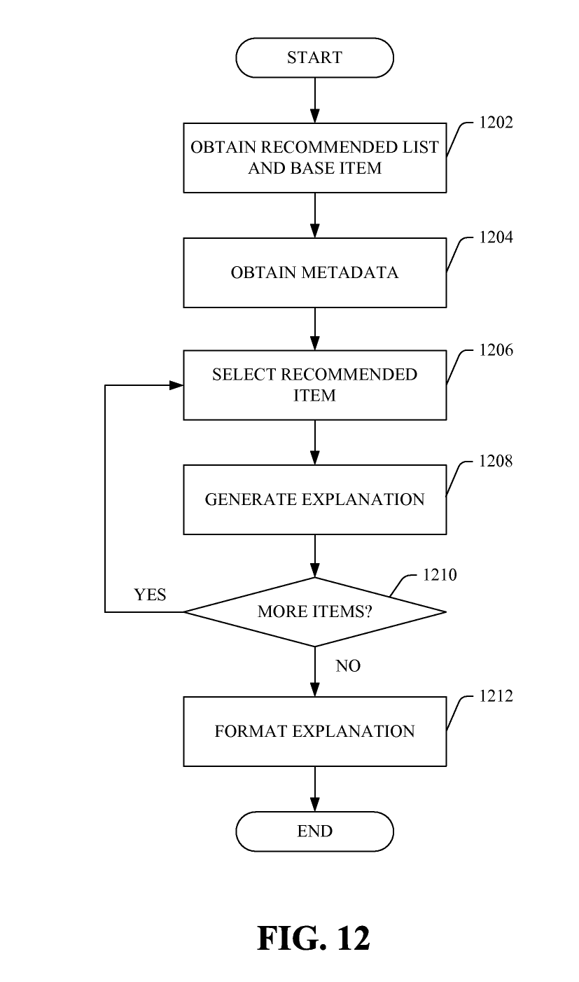

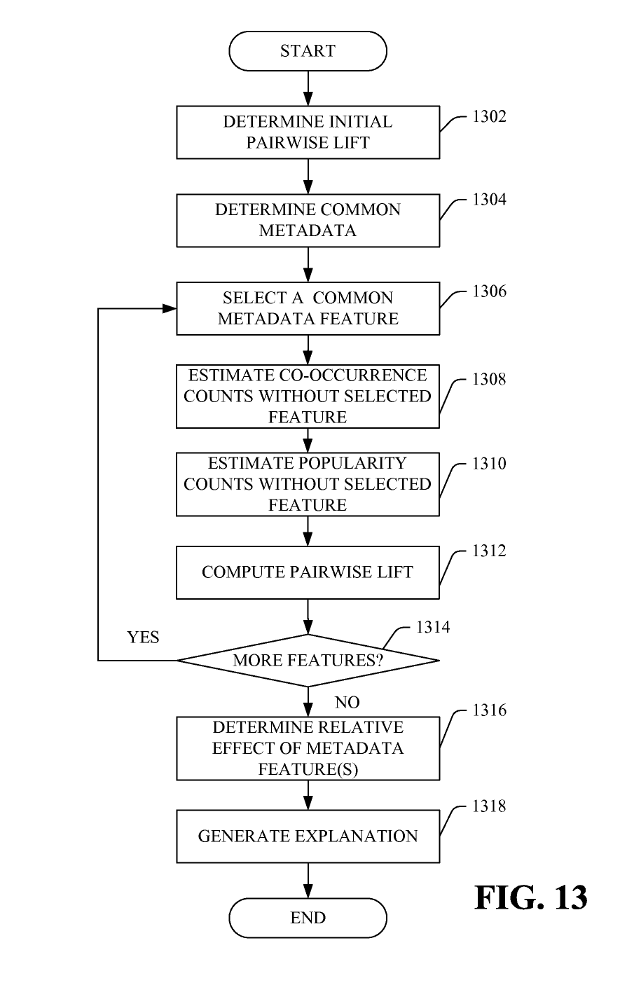

Turning now to FIG. 12, a methodology for generating explanations for a recommended set or list of items is illustrated. At 1202, a list of recommended items and a base item used to generate the recommended list of items is obtained. Metadata associated with the recommended items and the base item can be obtained at 1204. At 1206, one of the recommended items can be selected and the explanation for the selected item can be generated at 1208. The explanation can be based upon the common metadata features between the recommended item and the base item. In particular the most relevant common metadata can be determined by evaluating estimated or predicted pair-wise lift for the selected item and base item pair as described in further detail with respect to FIG. 13. A determination as to whether there are additional recommended items to evaluate is made at 1210. If yes, the process returns to 1206, where the next recommended item is selected. If no, the explanations can be formatted and provided to a user interface.

Referring now to FIG. 13, a methodology for generating an explanation for an item pair is illustrated. At 1302, an initial estimated pair-wise lift for an item pair is computed based upon metadata associated with the base item and recommended item of the item pair. As described in detail above, the estimated pair-wise lift can be a function of estimated popularity and co-occurrence counts for the item pair. This initial estimate of pair-wise lift can be utilized as a reference during the explanation generation process. At 1304, common metadata features between the recommended item and the base pair are determined. Common metadata features can be evaluated as a possible explanation of the item recommendation. One of the common metadata features is selected for evaluation at 1306. At 1308, the co-occurrence counts are computed for the item pair without utilizing the selected metadata feature. At 1310, popularity counts for each item are generated without utilizing the selected metadata feature. A new estimated pair-wise lift is generated based upon the co-occurrence and popularity counts at 1312. The change in lift from the initial estimated pair-wise lift to the newly generated lift is indicative of the importance of the selected metadata feature in the item recommendation. At 1314, a determination is made as to whether there are additional common metadata features to evaluate. If yes, the process returns to 1306, where the next metadata feature is selected for evaluation. If no, the metadata feature or features having the greatest impact are determined at 1316 based upon the change to estimated pair-wise lift caused by removal of a metadata feature. An explanation can be generated based upon the relevant metadata feature or features at 1318.

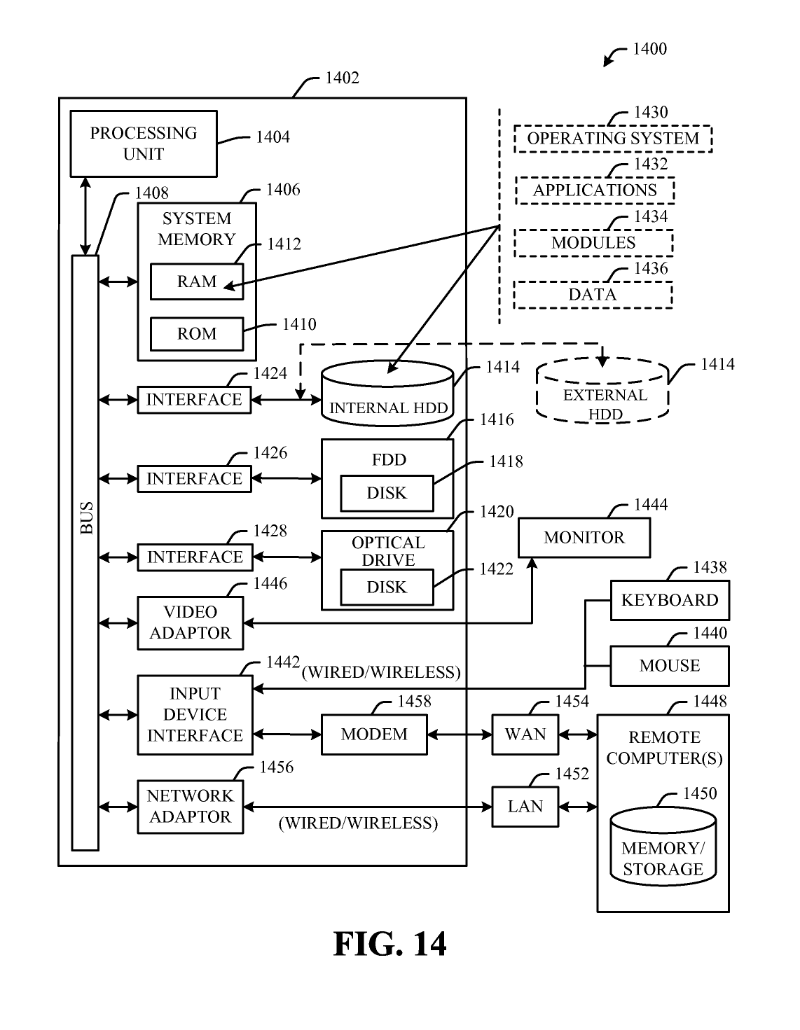

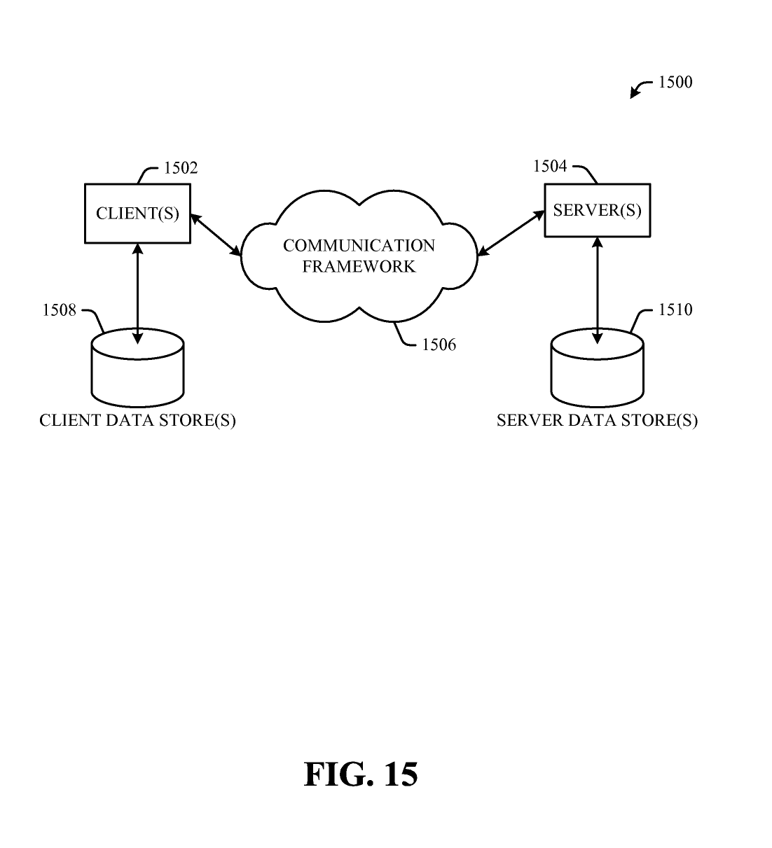

In order to provide a context for the various aspects of the disclosed subject matter, FIGS. 14 and 15 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the system and methods disclosed herein also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics (e.g., personal media players, television set top boxes, digital video recorders, video game systems) and the like. The illustrated aspects may also be practiced in distributed computing environments where tasks are performed by remote processing devices that are linked through a communications network. However, some, if not all aspects of the systems and methods described herein can be practiced on stand-alone computers. In a distributed computing environment, program modules may be located in both local and remote memory storage devices.

With reference again to FIG. 14, the exemplary environment 1400 for implementing various aspects of the embodiments includes a mobile device or computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures may also be employed as the processing unit 1404.

The system memory 1406 includes read-only memory (ROM) 1410 and random access memory (RAM) 1412. A basic input/output system (BIOS) is stored in a non-volatile memory 1410 such as ROM, EPROM, EEPROM, which BIOS contains the basic routines that help to transfer information between elements within the computer 1402, such as during start-up. The RAM 1412 can also include a high-speed RAM such as static RAM for caching data.

The computer or mobile device 1402 further includes an internal hard disk drive (HDD) 1414 (e.g., EIDE, SATA), which internal hard disk drive 1414 may also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (USB) and IEEE 1194 interface technologies. Other external drive connection technologies are within contemplation of the subject systems and methods.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods for the embodiments of the data management system described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. It is appreciated that the systems and methods can be implemented with various commercially available operating systems or combinations of operating systems.

A user can enter commands and information into the computer 1402 through one or more wired/wireless input devices, e.g. a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 1194 serial port, a game port, a USB port, an IR interface, etc. A display device 1444 can be used to provide a set of group items to a user. The display devices can be connected to the system bus 1408 via an interface, such as a video adapter 1446.

The mobile device or computer 1402 may operate in a networked environment using logical connections via wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, e.g. a wide area network (WAN) 1454. Such LAN and WAN networking environments are commonplace in offices and companies, and facilitate enterprise-wide computer networks, such as intranets, all of which may connect to a global communications network, e.g., the Internet.

When used in a LAN networking environment, the computer 1402 is connected to the local network 1452 through a wired and/or wireless communication network interface or adapter 1456. The adaptor 1456 may facilitate wired or wireless communication to the LAN 1452, which may also include a wireless access point disposed thereon for communicating with the wireless adaptor 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired or wireless device, is connected to the system bus 1408 via the serial port interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with any wireless devices or entities operatively disposed in wireless communication, e.g., a printer, scanner, desktop and/or portable computer, PDA, communications satellite, any piece of equipment or location associated with a wirelessly detectable tag (e.g. a kiosk, news stand, restroom), and telephone. The wireless devices or entities include at least Wi-Fi and Bluetooth™ wireless technologies. Thus, the communication can be a predefined structure as with a conventional network or simply an ad hoc communication between at least two devices.

Wi-Fi allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

FIG. 15 is a schematic block diagram of a sample-computing environment 1500 with which the systems and methods described herein can interact. The system 1500 includes one or more client(s) 1502. The client(s) 1502 can be hardware and/or software (e.g. threads, processes, computing devices). The system 1500 also includes one or more server(s) 1504. Thus, system 1500 can correspond to a two-tier client server model or a multi-tier model (e.g., client, middle tier server, data server), amongst other models. The server(s) 1504 can also be hardware and/or software (e.g., threads, processes, computing devices). One possible communication between a client 1502 and a server 1504 may be in the form of a data packet adapted to be transmitted between two or more computer processes. The system 1500 includes a communication framework 1506 that can be employed to facilitate communications between the client(s) 1502 and the server(s) 1504. The client(s) 1502 are operably connected to one or more client data store(s) 1508 that can be employed to store information local to the client(s) 1502. Similarly, the server(s) 1504 are operably connected to one or more server data store(s) 1510 that can be employed to store information local to the servers 1504.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

What is claimed is:

1. A system for facilitating item recommendations, comprising:
a metadata component that obtains metadata associated with a base item and a candidate item; and
a pair-wise lift predictor component that predicts pair-wise lift as a function of the metadata of the base item and the candidate item.

2. The system of claim 1, the pair-wise lift predictor component comprises a four-state model that determines probability of popularity of the base item, probability of popularity of the candidate item and probability of co-occurrence of the base item and the candidate item.

3. The system of claim 2, the four-state model comprises a linear model.

4. The system of claim 3, the model is trained utilizing sampled actual usage data.

5. The system of claim 1, the predicted pair-wise lift is based at least in part upon actual usage data.

6. The system of claim 5, the predicted pair-wise lift is based at least in part upon a combination of the actual usage data and an estimated base item popularity count, an estimated candidate item popularity count and an estimated co-occurrence count for the base item and candidate item.

7. The system of claim 1, further comprising:
a co-occurrence component that generates a co-occurrence count for the base item and the candidate item; and
a popularity component that generates a popularity count for the base item and a popularity count for the candidate item, the predicted pair-wise lift is based at least in part upon the base item popularity count, the candidate item popularity count and the co-occurrence count.

8. The system of claim 7, the co-occurrence component comprises a logistic regression model.

9. The system of claim 7, the popularity component comprises a logistic regression model.

10. The system of claim 1, further comprising a metadata evaluation component that analyzes and formats the metadata for use in pair-wise lift prediction.

11. The system of claim 1, further comprising a pair-wise lift component that generates actual pair-wise lift when sufficient usage data is available.

12. The system of claim 1, further comprising a recommendation component that selects at least one recommended item based at least in part upon the predicted pair-wise lift.

13. A method for generating explanations for item recommendations, comprising:
obtaining a base item and a recommended item;
identifying at least one common feature of the base item and the recommended item based at least in part upon metadata associated with the base item and the recommended item;
predicting pair-wise lift as a function of the metadata;
determining the effect of the at least one common feature on the predicted pair-wise lift; and
generating an explanation corresponding to the recommended item based upon the effect of the at least one common feature.

14. The method of claim 13, further comprising utilizing a greedy search algorithm to determine the at least one common feature that has the greatest impact upon the predicted pair-wise lift.

15. The method of claim 13, further comprising:
generating a natural language text string based at least in part upon the explanation; and
providing the text string to a user interface for presentation to a user.

16. The method of claim 13, predicting pair-wise lift further comprises:
predicting popularity of the recommended item as a function of the metadata;
predicting popularity of the base item as a function of the metadata;
predicting co-occurrence of the recommended item and the base item as a function of the metadata; and
computing pair-wise lift as a function of the recommended item popularity, the base item popularity and the co-occurrence.

17. The method of claim 16, the co-occurrence and the popularity are based at least in part upon a joint, four state model.

18. The method of claim 16, the co-occurrence is based at least in part upon a logistic regression model.

19. The method of claim 16, the base item popularity and the recommended item popularity are based at least in part upon a logistic regression model.

20. A system for facilitating generation of recommendations, comprising:
means for estimating an occurrence count for a base item and an occurrence count for a candidate item as a function of metadata;
means for estimating a pair-wise count for the base item and the candidate item as a function of the metadata; and
means for generating an estimated pair-wise lift based upon the base occurrence count, the candidate occurrence count and the pair-wise count.
